(19) United States
(12) Patent Application Publication
(10) Pub. No.: US 2004/0065402 A1
(43) Pub. Date: Apr. 8, 2004

(54) Textured packaging film

(76) Inventors: Anthony Robert Knoerzer, Plano, TX (US); Garrett William Kohl, Allen, TX (US)

Correspondence Address: CARSTENS YEE & CAHOON, LLP, P O BOX 802334, DALLAS, TX, 75380

(21) Appl. No.: 10/265,782

(22) Filed: Oct. 7, 2002

(51) Int. Cl. B32B 31/04

(52) U.S. Cl. 156/209; 156/553

(57) ABSTRACT

An embossing step is incorporated into a laminating step as two layers of a packaging material are laminated together by a sheet of molten resin. The design is carried on either the nip roller or chill roller that presses and cools the material during and after the laminating process. Combining the processes gives the capability to emboss an image into the hot material with less pressure than previously necessary. The images can be more detailed while at the same time the barrier properties of the material are damaged less.

### BACKGROUND OF THE INVENTION

1. Technical Field

The present invention relates to packaging films, such as are used to package snack foods and other items. More specifically, the invention relates to providing an improved method and apparatus for the embossing of a design or texture on such packaging film.

2. Description of Related Art

Snack foods and other items are often packaged in bags formed from packaging films. A typical film used for this packaging is seen in FIG. 1. The outermost layer 102 is an OPP layer, short for oriented polypropylene, while the innermost layer 106 is a metalized OPP. An oriented polymer material has been specially treated so that the long polymeric molecules tend to align in a given direction, causing the material to preferentially tear in that direction. Sandwiched between the two OPP layers is a layer 104 of polyethylene. Printing for the package is done on the inside of the outer layer and becomes sandwiched between the middle and outer layers. The innermost, metallic layer 106 can itself be a layered laminate and contains a sealant layer 108 on what will be the inside of the package. This sealant layer is formed of a ter-polymer, composed of ethylene, propylene, and butylenes, and provides a barrier to retain taste and freshness. Other materials used in packaging are polyester, paper, polyolefin extrusions, adhesive laminates, and other such materials, or a layered combination of the above.

The OPP layers of the packaging material are separately manufactured and are then formed into the final material on a laminator as seen in FIG. 2. In this example, the material 200 output from the laminator is the same material discussed in FIG. 1 above. Sheet 202 is fed from roll 201 and will become the outer layer 102 of the material 100 shown in FIG. 1; likewise sheet 206 of material is fed from roll 205 and will become the inner layer 106 of the material 100. At the same time, resin for PE laminate layer 104 is fed into hopper 218 and through extruder 216 to be heated to approximately 600° F. and extruded at die 214 as a molten sheet of resin 204. This molten sheet of resin 204 is extruded at a rate that is congruent with the rate at which the sheet materials 202, 206 are fed, becoming sandwiched between these two materials to form PE laminate layer 104. The material 200 then runs between chill drum 210 and nip roller 212, ensuring that it forms an even layer as it is cooled. The pressure between the laminator rollers tends to be in the range of 0.5 to 5 pounds per linear inch across the width of the material. The large chill drum 210 is made of stainless steel and is cooled to about 50-60° F., so that while the material is cooled quickly, no condensation is allowed to form. The smaller nip roller 212 is generally formed of rubber or another resilient material. The nip roller 212 tends to wear out fairly quickly and is regularly replaced, while the chill drum 210 is changed much less frequently. Note that the layered material remains in contact with the chill drum for a period of time after it has passed through the rollers, to allow time for the resin to cool sufficiently. The material can then be formed into rolls (not specifically shown) for transport to the location where it will be used in packaging.

It can be desirable to emboss the packaging material for added advertising effect and customer appeal. This has previously been done in a step downstream of the laminating machine just described and is demonstrated in FIG. 3. In this diagram, the formed material 100 is passed through a set of rollers 302, 304. The desired design is formed on each of the rollers 302, 304, but is in a raised, male form 316 on the first roller 302, while it is in a reverse, female form 318 on the second roller 304. As the film 310 passes between the rollers 302, 304, the rollers apply pressure to the film in the range of 50 pounds per square inch to emboss the design on the film 310. Note that the design can appear periodically on the roller, which is shown in this figure by the presence of the design in one area only, or can extend around the entire roller. In either case, the design will repeat once for every rotation of the rollers. FIG. 4 shows a logo for the assignee of this application, which has been produced using this technique. While this method works, it has several drawbacks. A large amount of pressure is necessary to emboss the design into the film. This can cause thinning and stretching of the film and can particularly affect the barrier properties of the innermost layer, thus the ability to maintain freshness and flavor.

U.S. Pat. No. 6,296,731, which is hereby incorporated by reference, discloses a method for embossing a decorative sheet of resin as it is formed on another sheet of resin. FIG. 5, which is adapted from a drawing in U.S. Pat. No. 6,296,731, demonstrates that process. An endless moving belt 514 is formed of a metallic material having a mirror face. The endless belt moves around three rollers 521, 522, 523, which are placed to form a triangle, with at least one of the three rollers connected to a drive means. An embossing roller 516 projects into one side of the triangle thus formed, so that the endless belt 514 partially wraps around the embossing roller 516 as it moves. The two rollers 521, 523 that lead material toward the embossing roller 516 provide heating to the endless belt 514, while the roller 522 that leads material away from the embossing roller 516 is provided with a means to cool the belt and the material formed thereon. A sheet of material 512 is fed from the roll 517 such that it adheres to the surface of the heated endless belt as it wraps partially around the adjacent roller 521. As the sheet of material 512 is led toward the embossing roller 516 and heated, an extrusion mechanism feeds molten resin through a die 529 so that it forms a sheet of resin 513 on top of the original sheet of material 512. The material, which now has two layers 512, 513 is then carried partially around the embossing roller 516, which embosses the newly formed layer 513. The two, now bonded layers 512, 513, are carried by the endless belt 514 into contact with roller 522, which provides cooling for the layers, then the bonded, embossed material 512, 513 is removed from the endless belt and placed on rolls (not shown). While this method can form a more detailed texture than the method described previously, it requires additional equipment, including an endless metallic belt and means for heating that belt.

Thus, it would be desirable to find a method of embossing a packaging material that uses low pressure, maintains the integrity of the bag, and improves the detail level in the embossed design, while not requiring additional equipment.

### SUMMARY OF THE INVENTION

In the disclosed method and apparatus, embossing is done at the same time as the laminating step, while the film is still hot from the heated resin, by placing the male form of the embossing on either the nip roller or the chill roller. Because the resin is still hot, a female version of the embossing is not necessary and less pressure is required, yet the detail of the embossing is improved without the need for additional equipment. Preferably, the nip roller carries the imprint, as it is smaller, less expensive, and more easily replaced than the chill drum.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 graphically shows the various layers of a typical packaging film.

FIG. 2 shows a laminator as it bonds two layers of film together.

FIG. 3 shows an embossing step as performed in the prior art.

FIG. 4 shows a typical design embossed on a packaging material using the prior art.

FIG. 5 shows an example of a layer being embossed as it is formed from molten plastic in the prior art.

FIG. 6 shows a combined laminating and embossing step, according to an embodiment of the invention.

FIG. 7 shows a design that can be embossed on a packaging material using the method according to an embodiment of the invention.

### DETAILED DESCRIPTION

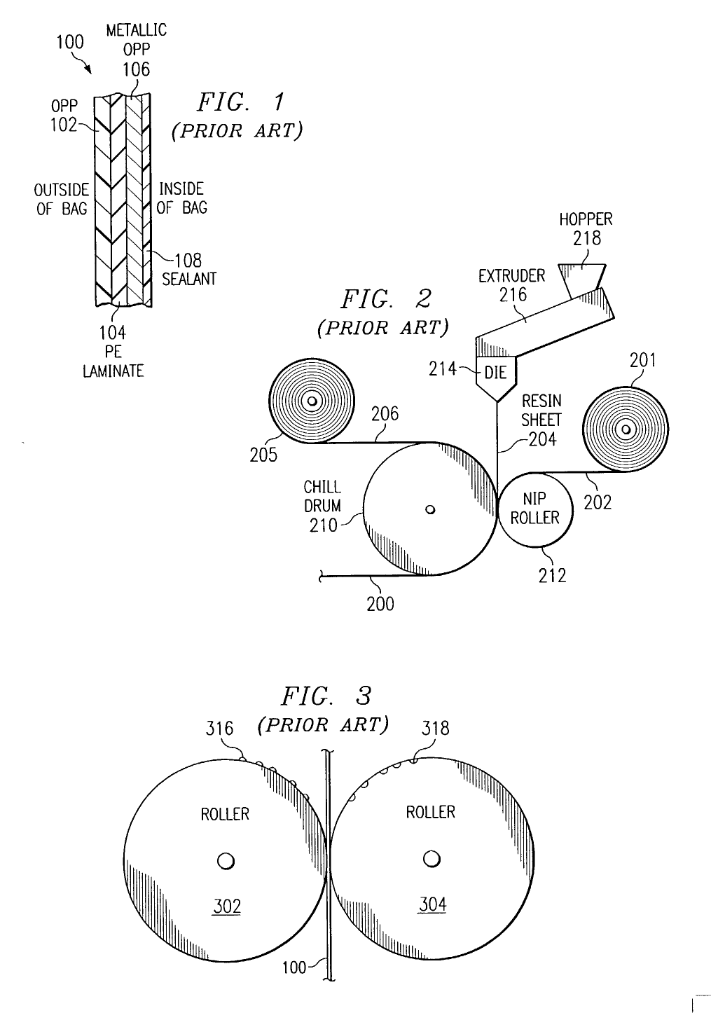

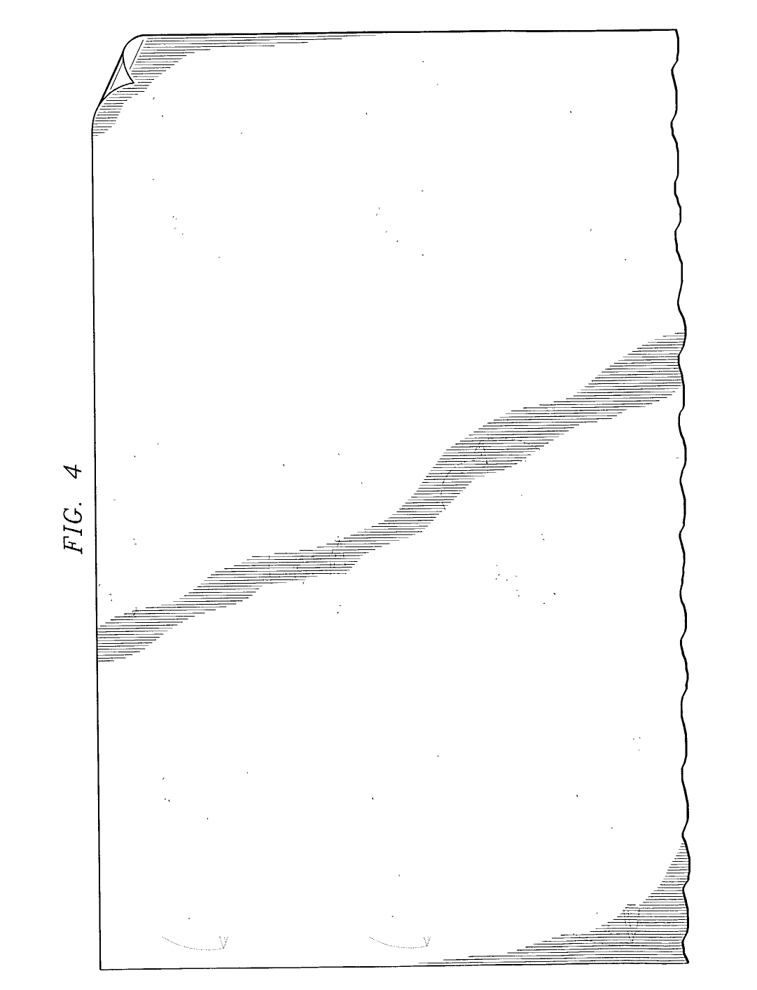

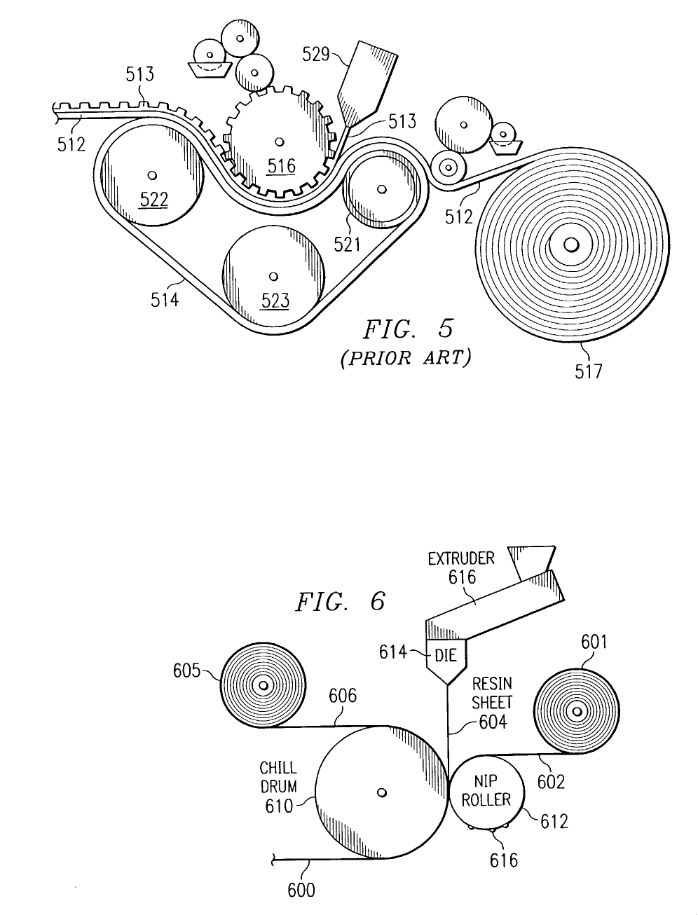

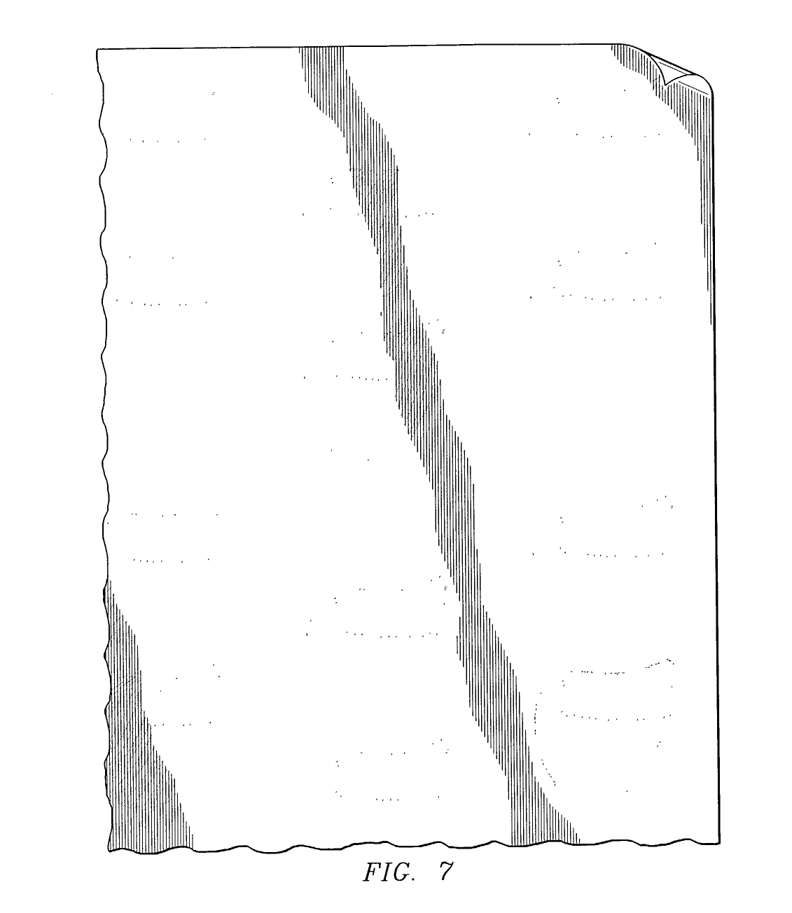

An embodiment of the innovative invention will now be described with reference to FIG. 6, in which packaging film 600 is formed. It can be seen that FIG. 6 is very similar to prior art FIG. 2. However, in the present drawing, the nip roller 612 contains raised embossing areas 616 that form a design for embossing on the film. As the two sheet materials 602, 606 are fed from rolls 601, 605 and mated together, the resin is extruded by the extruders 616 through die 614, to form resin sheet 604. In this embodiment, however, a design is carried in raised areas 616 on the nip roller 612. Unlike the rollers of FIG. 3, no female impression is necessary on the chill roller 610. Because the hot resin will heat the entire film, the film is softer and more pliable than at any other time during the process. By embossing the design at this point in the manufacture, less pressure is necessary, but the design carries more detail than it previously did. Additionally, the barrier layer of the film retains its integrity, so that the use of embossing will have no adverse effects on the flavor retention or freshness of the product carried in the package.

In an alternate embodiment, the design can be carried on the chill roller, rather than on the nip roller. This embodiment, however, is less preferred since the chill roller is larger, more expensive, and both more difficult and more time-consuming to replace than the nip roller.

FIG. 7 is an example of a design embossed using the disclosed technique. This design is of a Ruffles® potato chip, one of the products sold by the assignee of this application. Notably, the design has a great deal more detail and texture than was possible using the previous method used in packaging films.

In conclusion, the innovative device and process produce a better product with very small changes to the existing process. The barrier properties of the inner layer are maintained, with no loss of barrier protection during the embossing process, yet the detail of the embossing is improved. The embossing can now be accomplished without additional equipment to that previously used, by altering the existing equipment to fulfill the additional needs.

What is claimed is:

1. A device for embossing packaging materials, said device comprising:
a first roller connected to carry a first substantially continuous sheet of packaging material;
a second roller connected to carry a second substantially continuous sheet of packaging material such that said first sheet of packaging material and said second sheet of packaging material are brought together to rollingly pass between said first roller and said second roller; and
an extruder and die connected to extrude a sheet of molten resin substantially between said first and said second rollers;
wherein said second roller has a design carried on a surface thereof for embossing said second sheet of packaging material as it passes between said first roller and said second roller.

2. The device of claim 1, wherein said first roller is a chill drum and said second roller is a nip roller.

3. The device of claim 1, wherein said second roller is a chill drum and said first roller is a nip roller.

4. The device of claim 1, wherein said design on said second roller is raised.

5. The device of claim 1, wherein said resin extruder is connected to extrude resin at a temperature of approximately 600° F.

6. The device of claim 1, wherein said chill drum is operated at a temperature of approximately 50° F.

7. A device for embossing packaging materials, said device comprising:
a chill drum;
a nip roller, connected to rollingly pass a packaging material between said chill drum and said nip roller, wherein either said chill drum or said nip roller has a raised design carried on a surface thereof for embossing the packaging material passed between said chill drum and said nip roller; and
a resin extruder, connected to extrude molten resin between layers of packaging material as the layers are entering the space between said chill drum and said nip roller.

8. The device of claim 7, wherein said resin extruder is connected to extrude resin at a temperature of approximately 600° F.

9. The device of claim 7, wherein said chill drum is operated at a temperature of approximately 50° F.

10. A method of embossing a packaging material, said method comprising the steps of:
laminating a first layer and a second layer of a packaging material together with a molten resin as said first layer and said second layer of the packaging material are run between first and second opposed rollers; and
embossing a design on said first layer and said second layer of the packaging material simultaneously with said laminating step, said design being carried on a surface of either said first or said second roller.

11. The method of claim 10, further comprising the step of cooling the packaging material after said laminating and embossing steps.

12. The method of claim 10, further comprising the step of rolling the packaging material after said laminating and embossing steps.
